(19) United States
(12) Patent Application Publication
(10) Pub. No.: US 2026/0196464 A1
(43) Pub. Date: Jul. 9, 2026

(54) A PROCESS FOR PREPARING AN ELECTRODE

(71) Applicant: OLA ELECTRIC MOBILITY LIMITED, Bengaluru (IN)

(72) Inventors: Shishir Kumar SINGH, Azamgarh (IN); Himadri RAHA, Badkulla (IN); Neelakshi SHARMA, Bengaluru (IN)

(21) Appl. No.: 18/868,527

(22) PCT Filed: Dec. 12, 2023
(86) PCT No.: PCT/IN2023/051166

§ 371 Date: Nov. 22, 2024

(30) Foreign Application Priority Data
Oct. 23, 2023 (IN) 202341072394

(51) Int. Cl. H01M 4/04; H01M 4/131; H01M 4/62; H01M 10/0569

(52) U.S. Cl. CPC H01M 4/0435; H01M 4/131; H01M 4/623; H01M 4/625; H01M 10/0569; H01M 2300/004

(57) ABSTRACT

The present disclosure provides a process for preparing an electrode, the process comprising: (a) mixing an active material, a first conductive carbon, and a first binder to obtain a first mixture; (b) high shear mixing the first mixture with a second binder to obtain a second mixture, wherein the second binder is different from the first binder; (c) cooling the second mixture and blending with a second conductive carbon to obtain a third mixture; and (d) jet milling the third mixture and processing it to obtain the electrode. The present disclosure further provides an electrode obtained by the process as disclosed herein, and an electrochemical cell comprising at least one of the electrodes obtained by the process as disclosed herein.

### FIELD OF INVENTION

The present disclosure broadly relates to the field of battery. Particularly, the present disclosure relates to a process for preparing an electrode.

### BACKGROUND OF INVENTION

With increasing global demand for batteries, finding more efficient fabrication methods to obtain efficient electrodes is of huge global interest. Wet coating techniques for the preparation of electrodes are complicated and leads to environmental pollution due to the volatilization of the solvent. Additionally, existence of solvent residue in the electrode leads to reduced performance of the electrode. Moreover, for appreciable recovery of the solvent used, and still achieve enhanced capacity for the prepared electrode, the requirements are relatively difficult and costly.

In view of the above, the electrodes can alternatively be prepared by dry process. The dry process of preparing the electrode is simple, convenient, compatible due to avoiding of solvent volatilization, and result in better performance under high temperature conditions. The conventional dry electrode processes mainly adopt hot pressing of a mixture of fibrillating binder, conductive additives and active material to obtain a film and laminating upon the current collector.

Some of the challenges faced by dry battery processes are with respect to high reactivity of fluorinated binders, agglomeration of conducting additives, and inefficient fibrillation of the binder resulting in poor mechanical strength of the electrode. All of the above-mentioned shortcomings of the dry battery electrode processes lead to deteriorated performance of an electrode. Hence, there is a need in the art to develop a convenient process by virtue of which efficient dry battery electrodes can be prepared.

### SUMMARY OF THE INVENTION

In a first aspect of the present disclosure, there is provided a process for preparing an electrode, the process comprising: a. mixing an active material, a first conductive carbon, and a first binder to obtain a first mixture; b. high shear mixing the first mixture with a second binder to obtain a second mixture, wherein the second binder is different from the first binder; c. cooling the second mixture and blending with a second conductive carbon to obtain a third mixture; and d. jet milling the third mixture and processing to obtain the electrode.

In a second aspect of the present disclosure, there is provided an electrode obtained by the process as disclosed herein.

In a third aspect of the present disclosure, there is provided a first electrochemical cell comprising: a. an anode obtained by the process as disclosed herein; b. a cathode; and c. an electrolyte.

In a fourth aspect of the present disclosure, there is provided a second electrochemical cell comprising: a. an anode; b. a cathode obtained by the process as disclosed herein; and c. an electrolyte.

In a fifth aspect of the present disclosure, there is provided a modified electrochemical cell comprising: a. an anode comprising the electrode obtained by the process as disclosed herein; b. a cathode comprising the electrode obtained by the process as disclosed herein; and c. an electrolyte.

These and other features, aspects, and advantages of the present subject matter will be better understood with reference to the following description. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF THE ACCOMPANYING FIGURES

In order that the disclosure may be readily understood and put into practical effect, reference will now be made to exemplary embodiments as illustrated with reference to the accompanying figures. The figures together with a detailed description below, are incorporated in and form part of the specification, and serve to further illustrate the embodiments and explain various principles and advantages, in accordance with the present disclosure wherein:

FIG. 1 depicts SEM (scanning electron microscopy) images of powder prepared via (a) process 1, (b) process 2; cross-section of the electrode prepared via (c) process 1, (d) process 2; and surface of electrode prepared via (e) process 1 and (f) process 2, in accordance with an embodiment of the present disclosure.

FIG. 2 depicts electrochemical performance of the anodes A and B prepared via process 1 and 2 respectively showing (a) first cycle capacity, (b) comparison of reactivity and (c) life cycle analysis for electrode prepared for processes 1 and 2, in accordance with an embodiment of the present disclosure.

FIG. 3 depicts the comparative illustration of the through plane conductivity of the anodes prepared by the process-1 and process-2, in accordance with an embodiment of the present disclosure.

### DETAILED DESCRIPTION OF THE INVENTION

Those skilled in the art will be aware that the present disclosure is subject to variations and modifications other than those specifically described. It is to be understood that the present disclosure includes all such variations and modifications. The disclosure also includes all such steps, features, compositions, and compounds referred to or indicated in this specification, individually or collectively, and any and all combinations of any or more of such steps or features.

### Definitions

For convenience, before further description of the present disclosure, certain terms employed in the specification, and examples are delineated here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”.

Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

The term “w/w” means the percentage by weight, relative to the weight of the total composition, unless otherwise specified.

The term “at least one” is used to mean one or more and thus includes individual components as well as mixtures/combinations.

The term “active material” refers to the active constituent of an electrode, which comprises the particles that undergo oxidation or reduction, resulting in reversible ion storage. The active material of the present disclosure is a combination of an active component, and a conducting material. Examples of active component in the present disclosure includes but not limited to graphite, silicon, silicon-graphite, nickel-manganese-cobalt oxide (NMC), lithium-nickel-cobalt-aluminium oxides (NCA), lithium iron phosphate (LFP), or lithium-manganese-rich (LMR).

The term “conductive carbon” refers to an electrically conductive allotrope of carbon that provide channel for electronic movement, resulting in higher discharge capacity and better cycling performance. Examples of first conductive carbon could be such as carbon black, graphene, mesoporous carbon, acetylene black, activated carbon, super P, or combinations thereof. Examples of second conductive carbon includes but not limited to carbon nanofiber, vapour grown carbon nanofiber, carbon nanotube, or combinations thereof. The first conductive carbon is for improving the surface conductivity of the electrode mixture. The role of the second conductive carbon is to act as network and as a conducting channel. The second conductive carbon which have ribbon/tube like structures are able to form a network and make the connection with individual particles to facilitate smooth electronic conduction.

The term “binder” refers to the polymeric material employed in the preparation of an electrode to impart mechanical integrity to the electrode constituents. The binder could be a first binder or a second binder. A first binder or an adhesive binder holds the active material particles within the electrode of a battery together to maintain a strong connection between the electrode and the contacts. These binding materials are normally inert and have a significant role in the manufacturability of the battery. Examples of adhesive binder of the present disclosure includes but not limited to polyvinylidene fluoride (PVDF), hydroxypropyl methyl cellulose (HPMC), hydroxypropyl cellulose (HPC), hydroxyethyl cellulose (HEC), sodium carboxymethyl cellulose (Na-CMC), carboxymethyl cellulose (CMC), styrene butadiene rubber, polyethylene glycol (PEG), polyacrylic acid (PAA), polyethylene oxide (PEO) or combinations thereof. A second binder or a fibrillating binder is a type of the binder constituent of an electrode, which has the property to form small fibrils under the application of shear force. The fibrillating binder provides the mechanical integrity of the electrode during manufacturing and provide optimal dispersion and adhesion of the active material and conductive additive to the current collector. Examples of fibrillating binder in the present disclosure includes but not limited to polytetrafluoroethylene (PTFE), fluoroethylene vinyl ether (FEVE), fluorinated ethylene polymer (FEP), or combinations thereof.

The term “tip speed” refers to the tangential velocity of the mixer blade at its tip. It is a function of the RPM and diameter of the mixer blade.

In case of a mixer/blender,

tip speed=rotation speed×circumference of the mixer/blender (2πr), wherein r is the blade radius, and π is 3.14151.

In an aspect of the present disclosure, the blade radius is 97.5 mm, the blade circumference is 2×3.14×97.5=612.3 mm. In one revolution the blade covers 612.3 mm. At 1000 revolutions per min the blade covers 1000×612.3 which is equal to 612300 mm or 612.3 m. In one second, the blade covers 612.3÷60=−10.205 m. So, the tip speed is specified as the distance swept by the blade tip in one second which is ~10 m/s in one experimental setup. As the blade diameter increases (as in large mixers), the rpm required to achieve the same tip speed will decrease as the larger blade radius has a higher circumference.

The term “jet milling” refers to the process of grinding one or more materials by using a high-speed jet of compressed air or inert gas to impact particles into each other and result in uniform blending and specific particle size of the mixture. In an aspect of the present disclosure, the second binder is jet milled prior to the high shear mixing to obtain the jet milled binder having D50 particle size in a range of 50 to 300 micrometer. The reason for separate jet milling of the second binder is to reduce the particle size. Reduced particle size increases the surface to volume ratio, thus the extent of fibrillization increases. Carbon coating over PTFE is carried out, to reduce the chances of self-fibrillization of the second binder during the high energy jet milling process.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, weight percentage in the range of 0.1% to 2% (w/w) should be interpreted to include not only the explicitly recited limits of 0.1% to 2% (w/w) but also to include sub-ranges, such as 1% to 2% (w/w), 1.5% to 2% (w/w) and so forth, as well as individual amounts, including fractional amounts, within the specified ranges, such as 0.8% (w/w), 1.5% (w/w), and 0.95% (w/w).

Unless defined otherwise, all technical and scientific terms used herein have the same meaning as commonly understood by one of ordinary skill in the art to which this disclosure belongs. Although any methods and materials similar or equivalent to those described herein can be used in the practice or testing of the disclosure, the preferred methods, and materials are now described. All publications mentioned herein are incorporated herein by reference.

The present disclosure is not to be limited in scope by the specific embodiments described herein, which are intended for the purposes of exemplification only. Functionally equivalent products, compositions, formulations, and methods are clearly within the scope of the disclosure, as described herein.

As discussed in the background, there is a need in the art to develop a convenient process that result in an efficient electrode. Some of the major challenges in the existing technique are the formation of lithium fluoride owing to the high reactivity of the fluorinated binders, ineffective fibrillation of binders resulting in less mechanical integrity of the electrode, agglomeration of the conducting additives when employed in higher amounts resulting in carbonate residues which in turn lead to detrimental effects on the electrode performance in terms of decreased coulombic efficiency and reduced specific capacity.

Carbon based conductive additives are usually employed for enhancing the conducting channels in an electrode. However, most of the conductive carbon additives result in agglomerated products which result in lithium carbonate residues when subjected to electrochemical cycling. As an alternative or an additional option to be employed in the category of conductive carbon additives, fibrous carbons, such as vapour grown carbon fibers (VGCF), or carbon nanofibers (CNF) can be used. It has been observed that when electrode preparation was carried out using conventional processes, the distribution of conducting carbon nanofiber in the electrode powder is not uniform as well as fibrillization of PTFE binder is thick and non-uniform in the prepared electrodes. High volumes of accumulated conducting carbon nanofiber, non-fibrillated PTFE and PVDF particles were also observed when basic dry electrode processes were adopted. Hence, it can be inferred that the extent of uniform distribution of conducting carbon nanofiber as well as thin and dense fibrillization of the binders into the powder and electrode has to be improved.

In view of the above, there is a requirement to identify the controlling parameters in a dry electrode process, so as to achieve a free flowable electrode powder wherein the conducting carbon additive is uniformly distributed and the binder forms thin PTFE fibrils. It was found that processes that include jet milling result in an electrode powder without agglomerations of binder and carbon nanofiber based conductive additives for dry electrode batteries. However, such processes also require cautious control of the mixing and milling/feeding steps and parameters. Further, the fibrillating binder should be employed in such a manner that the effective fibrillation of the binders is facilitated to result in better adhesion and mechanical integrity of the electrode. A fibrillating binder with reduced particle size could result in a proper placement and compacting of the conductive carbon coated active materials. However, for the binder fibrillation to be effective, the specific parameter of the binder should be optimised to result in a better coating and uniform dispersion for structural stability.

In addition to the mechanical integrity of the electrode, achieving uniform dispersion with lower agglomeration of conductive carbon is essential for the electrical conductivity of the electrode. In order to facilitate smooth electronic conduction, a conductive carbon having ribbon/tube like structures can be preferably employed.

Accordingly, in an embodiment of the present disclosure, there is provided a process for preparing an electrode, the process comprising: a. mixing an active material, a first conductive carbon, and a first binder to obtain a first mixture; b. high shear mixing the first mixture with a second binder to obtain a second mixture, wherein the second binder is different from the first binder; c. cooling the second mixture and blending with a second conductive carbon to obtain a third mixture; and d. jet milling the third mixture and processing to obtain the electrode.

In an embodiment of the present disclosure, there is provided a process as disclosed herein, wherein mixing in step (a) is carried out at a temperature in a range of 0 to 25° C., at a tip speed in a range of 3 to 31 m/s, and for a time period in a range of 5 to 60 minutes. In another embodiment of the present disclosure, the mixing in step (a) is carried out at a temperature in a range of 10 to 25° C., at a tip speed in a range of 10 to 20 m/s, and for a time period in a range of 10 to 40 minutes. In yet another embodiment of the present disclosure, the mixing in step (a) is carried out at a temperature of 20 to 25° C., at a tip speed of 15 to 20 m/s, and for a time period in a range of 10 to 20 minutes.

In an embodiment of the present disclosure, there is provided a process for preparing an electrode, the process comprising: a. mixing an active material, a first conductive carbon, and a first binder at a temperature in a range of 0 to 25° C., at a tip speed in a range of 3 to 31 m/s, and for a time period in a range of 5 to 60 minutes to obtain a first mixture; b. high shear mixing the first mixture with a second binder to obtain a second mixture, wherein the second binder is different from the first binder; c. cooling the second mixture and blending with a second conductive carbon to obtain a third mixture; and d. jet milling the third mixture and processing to obtain the electrode.

In an embodiment of the present disclosure, there is provided a process as disclosed herein, wherein high shear mixing in step (b) is carried out at a tip speed in a range of 30 to 41 m/s, for a period in a range of 5 minutes to 60 minutes, until temperature of the second mixture is in a range of 65 to 85° C. In another embodiment of the present disclosure, high shear mixing in step (b) is carried out at a tip speed in a range of 30 to 35 m/s, for a period in a range of 8 minutes to 30 minutes, until temperature of the second mixture is in a range of 68 to 75° C. In yet another embodiment of the present disclosure, high shear mixing in step (b) is carried out at a tip speed in a range of 30 to 35 m/s, for a period in a range of 10 minutes to 20 minutes, to attain a temperature in a range of 69 to 72° C. In still another embodiment of the present disclosure, high shear mixing in step (b) is carried out at a tip speed in a range of 30 to 35 m/s, for a period in a range of 10 minutes to 20 minutes, until temperature of the second mixture is in a range of 82 to 85° C.

In an embodiment of the present disclosure, there is provided a process for preparing an electrode, the process comprising: a. mixing an active material, a first conductive carbon, and a first binder at a temperature in a range of 0 to 25° C., at a tip speed in a range of 3 to 31 m/s, and for a period in a range of 5 to 60 minutes to obtain a first mixture; b. high shear mixing the first mixture with a second binder at a tip speed in a range of 30 to 41 m/s, for a period in a range of 5 minutes to 60 minutes, at a temperature in a range of 65 to 85° C., to obtain a second mixture, wherein the second binder is different from the first binder; c. cooling the second mixture and blending with a second conductive carbon to obtain a third mixture; and d. jet milling the third mixture and processing to obtain the electrode.

In an embodiment of the present disclosure, there is provided a process as disclosed herein, wherein cooling is carried out with low speed mixing at a tip speed in a range of 3 to 20 m/s, at a temperature below 19° C. In another embodiment of the present disclosure, cooling is carried out with low speed mixing at a tip speed in a range of 5 to 18 m/s, at a temperature in a range of 0 to 19° C. In yet another embodiment of the present disclosure, cooling is carried out with low speed mixing at a tip speed in a range of 8 to 14 m/s, at a temperature in a range of 10 to 19° C.

In an embodiment of the present disclosure, there is provided a process as disclosed herein, wherein cooling is carried out at a controlled rate in a range of 2 to 10° C. per minute for a time interval in a range of 5 to 30 minutes. In another embodiment of the present disclosure, the cooling is carried out at a controlled rate in a range of 3 to 7° C. per minute for a time interval in a range of 8 to 20 minutes using an external cooling device set at a temperature in a range of 3 to 7° C.

In an embodiment of the present disclosure, there is provided a process as disclosed herein, wherein blending the second conductive carbon is carried out at a temperature in a range of 0 to 25° C. at a tip speed in a range of 3 to 12 m/s for a period in a range of 5 minutes to 2 hours. In another embodiment of the present disclosure, blending the second conductive carbon is carried out at a temperature in a range of 0 to 25° C. at a tip speed in a range of 9 to 11 m/s for a period in a range of 8 minutes to 1 hour. In yet another embodiment of the present disclosure, blending the second conductive carbon is carried out at a temperature in a range of 0 to 25° C. at a tip speed of 10 to 11 m/s for a period of 10 to 30 minutes.

In an embodiment of the present disclosure, there is provided a process for preparing an electrode, the process comprising: a. mixing an active material, a first conductive carbon, and a first binder at a temperature in a range of 0 to 25° C., at a tip speed in a range of 3 to 31 m/s, and for a period in a range of 5 to 60 minutes to obtain a first mixture; b. high shear mixing the first mixture with a second binder at a tip speed in a range of 30 to 41 m/s, for a period in a range of 5 minutes to 60 minutes, at a temperature in a range of 65 to 85° C. to obtain a second mixture, wherein the second binder is different from the first binder; c. cooling the second mixture with low speed mixing at a tip speed in a range of 3 to 20 m/s, at a temperature below 19° C., at a controlled rate in a range of 2 to 10° C. per minute for a time interval in a range of 5 to 20 minutes and blending with a second conductive carbon at a temperature in a range of 0 to 15° C. at a tip speed in a range of 3 to 7 m/s for a period in a range of 1 to 2 hours to obtain a third mixture; and d. jet milling the third mixture and processing to obtain the electrode.

In an embodiment of the present disclosure, there is provided a process as disclosed herein, wherein the processing comprises, calendaring, laminating, or combinations thereof. In another embodiment of the present disclosure, the processing comprises calendaring. In yet another embodiment of the present disclosure, the processing comprises calendaring followed by laminating upon a current collector. In still another embodiment of the present disclosure, the processing comprises laminating upon a current collector.

In an embodiment of the present disclosure, there is provided a process as disclosed herein, wherein jet milling is carried out at a temperature in a range of 0 to 19° C. In an embodiment of the present disclosure, there is provided a process as disclosed herein, wherein the jet milling is carried out at a feeding pressure in a range of 1 to 3 Kg/cm², a milling pressure in a range of 1 to 3 Kg/cm² by using a milling media and at a temperature in a range of 10 to 25° C.

In an embodiment of the present disclosure, there is provided a process for preparing an electrode, the process comprising: a. mixing an active material, a first conductive carbon, and a first binder at a temperature in a range of 0 to 25° C., at a tip speed in a range of 3 to 31 m/s, and for a period in a range of 5 to 60 minutes to obtain a first mixture; b. high shear mixing the first mixture with a second binder at a tip speed in a range of 30 to 41 m/s, for a period in a range of 5 minutes to 60 minutes, at a temperature in a range of 65 to 85° C. to obtain a second mixture, wherein the second binder is different from the first binder; c. cooling the second mixture with low speed mixing at a tip speed in a range of 3 to 20 m/s, at a temperature below 19° C., at a controlled rate in a range of 2 to 10° C. per minute for a time interval in a range of 5 to 20 minutes and blending with a second conductive carbon at a temperature in a range of 0 to 15° C. at a tip speed in a range of 3 to 7 m/s for a period in a range of 1 to 2 hours to obtain a third mixture; and d. jet milling the third mixture at a feeding pressure in a range of 1 to 3 Kg/cm² and a milling pressure in a range of 1 to 3 Kg/cm² and a temperature in a range of 0 to 19° C., followed by calendaring to obtain the electrode.

In an embodiment of the present disclosure, there is provided a process as disclosed herein, wherein the active material is selected from graphite, silicon, silicon-graphite, nickel-manganese-cobalt oxide (NMC), lithium-nickel-cobalt-aluminium oxides (NCA), lithium iron phosphate (LFP), or lithium-manganese-rich (LMR). In another embodiment of the present disclosure, the active material is graphite.

In an embodiment of the present disclosure, there is provided a process as disclosed herein, wherein the active material is in a range of 95 to 98% (w/w). In another embodiment of the present disclosure, the active material is in a range of 96 to 98% (w/w).

In an embodiment of the present disclosure, there is provided a process as disclosed herein, wherein the first conductive carbon is selected from carbon black, graphene, mesoporous carbon, acetylene black, activated carbon, super P or mixtures thereof. In another embodiment of the present disclosure, the first conductive carbon is super P.

In an embodiment of the present disclosure, there is provided a process as disclosed herein, wherein the first conductive carbon is in a weight range of 0.1 to 2% (w/w). In another embodiment of the present disclosure, the first conductive carbon is in a weight range of 0.3 to 1.5%. In yet another embodiment of the present disclosure, the first conductive carbon is in a weight range of 0.3 to 1%.

In an embodiment of the present disclosure, there is provided a process as disclosed herein, wherein the first binder is selected from polyvinylidene fluoride (PVDF), hydroxypropyl methyl cellulose (HPMC), hydroxypropyl cellulose (HPC), hydroxyethyl cellulose (HEC), sodium carboxymethyl cellulose (Na-CMC), carboxymethyl cellulose (CMC), styrene butadiene rubber, polyethylene glycol (PEG), polyacrylic acid (PAA), polyethylene oxide (PEO) or combinations thereof. In another embodiment of the present disclosure, the first binder is selected from polyvinylidene fluoride (PVDF), hydroxypropyl methyl cellulose (HPMC), hydroxypropyl cellulose (HPC), hydroxyethyl cellulose (HEC), sodium carboxymethyl cellulose (Na-CMC), carboxymethyl cellulose (CMC), or combinations thereof. In yet another embodiment of the present disclosure, the first binder is polyvinylidene fluoride (PVDF).

In an embodiment of the present disclosure, there is provided a process as disclosed herein, wherein the first binder is in a range of 0.1 to 2% (w/w). In another embodiment of the present disclosure, the first binder is in a weight range of 0.5 to 1.5%. In yet another embodiment of the present disclosure, the first binder is in a weight range of 0.8 to 1.2%.

In an embodiment of the present disclosure, there is provided a process as disclosed herein, wherein the second conductive carbon is selected from carbon nanofiber, vapour grown carbon nanofiber, carbon nanotube, or combinations thereof. In another embodiment of the present disclosure, the second conductive carbon is selected from carbon nanofiber, vapour grown carbon nanofiber, or combinations thereof. In yet embodiment of the present disclosure, the second conductive carbon is vapour grown carbon nanofiber.

In an embodiment of the present disclosure, there is provided a process as disclosed herein, wherein the second conductive carbon is in a range of 0.1 to 2% (w/w). In another embodiment of the present disclosure, the second conductive carbon is in a range of 0.3 to 1.5% (w/w). In yet another embodiment of the present disclosure, the second conductive carbon is in a range of 0.3 to 1% (w/w).

In an embodiment of the present disclosure, there is provided a process as disclosed herein, wherein the second binder is a fibrillating binder selected from polytetrafluoroethylene (PTFE), fluoroethylene vinyl ether (FEVE), or combinations thereof. In another embodiment of the present disclosure, the second binder is polytetrafluoroethylene (PTFE). In an embodiment of the present disclosure, there is provided a process as disclosed herein, wherein the second binder is a fibrillating binder selected as polytetrafluoroethylene (PTFE) which is jet milled at a milling pressure in a range of 0.5 to 2 kg/cm² and feeding pressure in a range of 1 to 3 kg/cm² prior to high shear mixing. In another embodiment of the present disclosure, the second binder is jet milled to result in a D50 particle size in a range of 50 to 300 micrometer.

In an embodiment of the present disclosure, there is provided a process as disclosed herein, wherein the second binder is jet milled prior to high shear mixing and the D50 particle size of the jet milled PTFE is in a range of 50 to 400 micrometer. In another embodiment of the present disclosure, the second binder is jet milled at a milling pressure in a range of 0.5 to 2 kg/cm² and feeding pressure in a range of 0.5 to 3 kg/cm² prior to high shear mixing and the D50 particle size of the jet milled PTFE is in a range of 50 to 350 micrometer. In another embodiment of the present disclosure, the second binder is jet milled at a milling pressure of 1 to 2 kg/cm² and feeding pressure of 1.5 to 2 kg/cm² prior to high shear mixing and the D50 particle size of the jet milled PTFE is in a range of 50 to 300 micrometer. The jet milled second binder is then stored at a temperature below 15° C. to prevent the second binder from fibrillating before being used in the process of preparation of the electrode.

In an embodiment of the present disclosure, there is provided a process as disclosed herein, wherein the second binder is in a weight range of 0.1 to 2% (w/w). In another embodiment of the present disclosure, the second binder is in a weight range of 0.5 to 1.5% (w/w). In yet another embodiment of the present disclosure, the second binder is in a weight of 0.8 to 1.25% (w/w).

In an embodiment of the present disclosure, there is provided an electrode obtained by the process as disclosed herein the electrode is laminated on a current collector. In another embodiment of the present disclosure, when the electrode is an anode, the current collector is selected from copper foil, copper rod, copper plate, copper-based sheets, carbon coated copper foil, carbon cloth, a metal foil, or the like. In another embodiment of the present disclosure, wherein the electrode is an anode, the current collector is selected from aluminium foil, aluminium sheet, glossy aluminium sheet, aluminium plate, aluminium rod, or the like.

In an embodiment of the present disclosure, there is provided an electrode as disclosed herein, wherein the electrode comprises: (a) an active material; (b) at least two conductive carbons; and (c) at least two binder.

In an embodiment of the present disclosure, there is provided an electrode as disclosed herein, wherein the electrode comprises: (a) an active material; (b) at least two conductive carbon; and (c) at least two binder, wherein the electrode exhibits a through plane conductivity in a range of 5 to 8 mS/cm. In another embodiment of the present disclosure, the electrode exhibits a conductivity in a range of 6 to 7 mS/cm. In yet another embodiment of the present disclosure, the electrode exhibits a conductivity of 6.8 mS/cm.

In an embodiment of the present disclosure, there is provided a first electrochemical cell comprising: a. an anode comprising the electrode obtained by the process as disclosed herein; b. a cathode; and c. an electrolyte.

In an embodiment of the present disclosure, there is provided a second electrochemical comprising: a. an anode; b. a cathode comprising the electrode obtained by the process as disclosed herein; and c. an electrolyte.

In an embodiment of the present disclosure, there is provided a modified electrochemical cell comprising: a. an anode comprising the electrode obtained by the process as disclosed herein; b. a cathode comprising the electrode obtained by the process as disclosed herein; and c. an electrolyte.

In an embodiment of the present disclosure, there is provided a modified electrochemical cell as disclosed herein, wherein the electrolyte is LiPF₆ in a solvent selected from ethyl carbonate (EC), dimethyl carbonate (DMC), ethyl methyl carbonate (EMC), or combinations thereof.

In an embodiment of the present disclosure, there is provided a modified electrochemical cell as disclosed herein, wherein the electrochemical cell further comprises a separator.

In an embodiment of the present disclosure, there is provided a use of the electrode as disclosed herein, as a working electrode.

In an embodiment of the present disclosure, there is provided a use as disclosed herein, wherein the electrode can be used in energy storage devices. In another embodiment of the present disclosure, the electrode can be used in supercapacitors, batteries, cells, etc.

### EXAMPLES

The disclosure will now be illustrated with following examples, which is intended to illustrate the working of disclosure and not intended to take restrictively to imply any limitations on the scope of the present disclosure. Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices, and materials are described herein. It is to be understood that this disclosure is not limited to particular methods, and experimental conditions described, as such methods and conditions may apply.

### Materials and Methods

The various chemicals and solvents used in the present disclosure are as follows:
Active material—Synthetic Graphite from Zichen
First conductive carbon—Super P from Imerys
Second conductive carbon—vapour grown carbon nanofiber (VGCF) from Showadenko.
First binder—Polyvinylidene fluoride (PVDF) from Arkema
Second binder—Polytetrafluoroethylene (PTFE) from Daikin

### Example 1

### Preparation of Electrode and Electrochemical Cell

### Preparation of Second Binder

The second binder polytetrafluoroethylene was mixed with Super P (first conductive carbon) at a weight ratio of 95:5, by low mixing (300 to 600 rpm, tip speed of 3 to 6 m/s) at low temperature (below 15° C.). After mixing, the PTFE having a particle size of about 500 micrometers, was stored at a temperature below 10° C. to prevent further agglomerations of PTFE before Jet milling. The mixed PTFE was then jet milled at a milling pressure of 1 kg/cm² and feeding pressure of 2 kg/cm² to obtain the second binder having D50 particle size of the jet milled PTFE in the range of 50 to 300 micrometer.

### Preparation of Anode

a. Process 1

About 97% (w/w) of graphite (active material), 0.5% (w/w) of super P (first conductive carbon), 0.5% (w/w) of vapour grown carbon nanofiber (VGCF, second conductive carbon) and 1% (w/w) of polyvinylidene fluoride (PVDF, first binder) were mixed to obtain a first mixture. The first mixture was then high shear mixed at a tip speed in a range of 30.6 m/s, for a period of 15 minutes, until the temperature reached 70° C. with 1% (w/w) of polytetrafluoroethylene (PTFE, second binder) to obtain a second mixture. The second mixture was then cooled by low-speed mixing at a tip speed of 12.25 m/s, to a temperature below 19° C. to obtain a third mixture. The temperature of the second mixture was brought below 19° C. using a chiller set at 5° C. The third mixture was then jet milled at a feeding pressure of 2 kg/cm², and milling pressure of 2 kg/cm². Further, the jet milled third mixture was subjected to calendering to obtain the anode A.

b. Process 2

About 97% (w/w) of graphite (active material), 0.5% (w/w) of super P (first conductive carbon), and 1% (w/w) of polyvinylidene fluoride (PVDF, first binder) were mixed at a temperature of 18° C., at a tip speed of 18.4 m/s, and for a period of 30 minutes to obtain a first mixture. The first mixture was then high shear mixed at a tip speed of 30.63 m/s, for a period in a range of 25 minutes, until the temperature reached 70° C. with 1% (w/w) of polytetrafluoroethylene (PTFE, second binder) obtained by the process as explained above, to obtain a second mixture. The second mixture was then cooled at a controlled rate of 5° C. per minute for 10 minutes by low-speed mixing at a tip speed in a range of 12.25 m/s, at a temperature below 19° C. using a chiller set at 5° C. The cooled second mixture was then blended with 0.5% (w/w) of vapour grown carbon nanofiber (VGCF, second conductive carbon) to obtain a third mixture. The third mixture was then jet milled at a feeding pressure of 2 kg/cm², and milling pressure of 2 kg/cm². Further, the jet milled third mixture was subjected to calendering to obtain the anode B.

### Preparation of Electrochemical Cell

A first electrochemical cell was prepared by assembling the anode B obtained by the process 2 as explained above adjacent to an electrolyte of 1M LiPF₆ dissolved in a 1:1:1 volume ratio solution of (ethylene carbonate) EC:ethyl methyl carbonate (EMC):dimethyl carbonate (DMC). On the opposite side of the electrolyte, a cathode of nickel-manganese-cobalt oxide (NMC) was arranged, to obtain the first electrochemical cell.

### Example 2

### Characterization of Anode

### Surface Morphology Studies

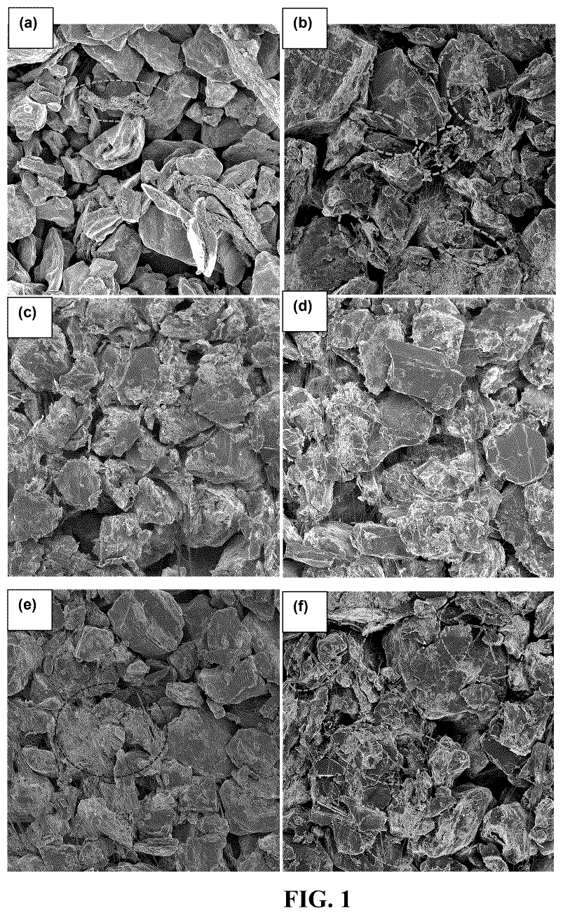

The scanning electron microscopic (SEM) images of the anodes prepared by the processes 1 and 2 are depicted in FIGS. 1 a-f. The anode A prepared by the process 1, wherein the conductive carbons were added in adjacent or single step, exhibited agglomeration of the second conductive carbon VGCF and lesser fibrillation of binder PTFE as shown in FIGS. 1 a, c, and e. As observed from FIG. 1a, the electrode particles of anode A exhibited agglomeration of conductive carbon (encircled) whereas, the anode B as shown in FIG. 1b exhibited uniform dispersion of the conductive carbon (encircled) with negligible agglomeration. Formation of the VGCF agglomerates in anode A was observed to happen due to the initiation of fibrillization of PTFE, during the high shear mixing. Further, as depicted in FIG. 1c, the electrode particles showed less compacting in comparison to the anode B depicted in FIG. 1d. in FIG. 1e, the anode A showed the weak and non-uniform binder fibrillation (encircled) in comparison to the anode B depicted in FIG. 1f, which showed better and enhanced fibrillation of binder that resulted in better mechanical integrity. Therefore, continuous distribution and efficient fibrillation of the PTFE films and uniform coating of conductive carbons was observed in the case of anode B prepared by the ‘Process 2’. The fibrous second conductive carbon did not agglomerate and was well distributed throughout the anode.

### B. Peel Strength and Conductivity Analysis

Peel strength and conductivity of the electrodes were measured respectively by ‘T-peel’ configuration and through plane electrochemical impedance spectroscopy (EIS) technique. Both these tests were carried out as per industry norms.

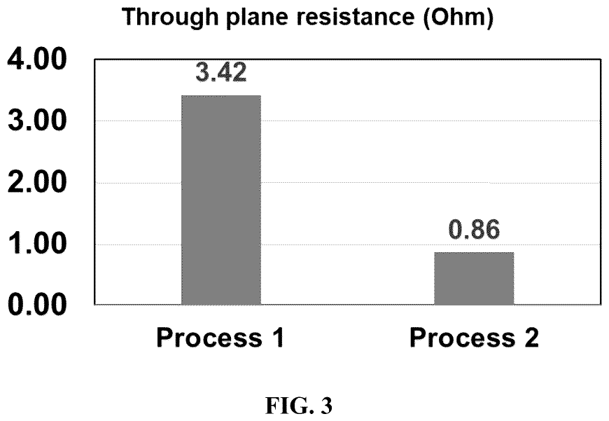

The methodology of measuring the through plane conductivity was by measuring the resistance. From the resistance, resistivity and corresponding conductivity was measured. The through plane resistance plot is shown in FIG. 3. The through plane resistance for the anode A was found to be much higher than the anode B.

Peel strength of the anode B was higher than that of the anode A (prepared by maintaining similar electrode density). Moreover, an improved fibrillization of PTFE was found in the anode B in terms of uniformity and density of the fibrils. The improvement in fibrillization was actually responsible for enhancing peel strength due to the improved cohesion between the adjacent electrode particles. Jet milling of the mixed powder eventually resulted in homogeneous mixing of the binder PTFE and PVDF particles in the anode mixture, which was found to be responsible for the uniform fibrillization in anode B.

The distribution of fibrous second conductive carbon (e.g., CNF, VGCF and CNT etc.) were not found to be uniform during mixing in anode A. The agglomerates of the fibrous second conductive carbon additives (marked red in FIG. 1a) was found on the surface of the anode A.

Further improvement of the second conductive carbon distribution was achieved in the anode B prepared by the ‘Process 2’, wherein second conductive carbon was added to the anode mix between the high shear mixing and final jet milling respectively. The anode B had increased peel strength by almost 65% from that of anode A prepared by basic process 1. Table 1 shows the peel strength and electrical conductivity exhibited by the anodes A and B.

TABLE 1

| Anode | [symbol] el Strength (kgf) | Electrical Conductivity (mS/cm) |
|---|---|---|
| A | 0.011 | 4.30 |
| B | 0.018 | 6.80 |

[symbol]

indicates data missing or illegible when filed

The electrical conductivity results of the anodes were also in alignment with the SEM results. The anode A wherein the second conductive carbon VGCF was found to form agglomerates, exhibited lower conductivity of about 4.3 mS/cm. However, the anode B with the uniform distribution of conductive carbons and effective fibrillation of PTFE exhibited a better conductivity of 6.8 mS/cm. The anode B exhibited improved electrical conductivity of the electrode by 2.5 ms/cm in comparison to the anode A.

### C. Electrochemical Analysis

The electrochemical analysis was conducted using an arrangement having working electrode as the anode A and B, counter electrode as Lithium metal for half-cell, in an electrolyte of 1M LiPF₆ dissolved in a solvent combination of ethyl carbonate (EC), dimethyl carbonate (DMC), and ethyl methyl carbonate (EMC) in a volume ratio of 1:1:1.

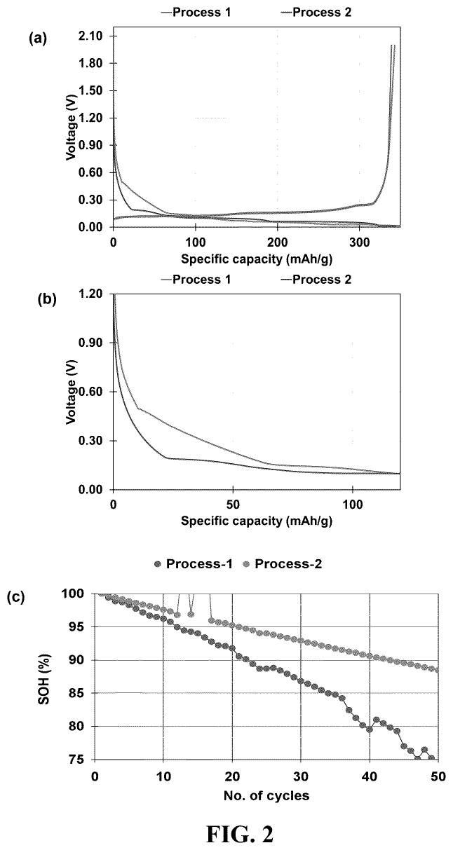

From the first cycle capacity plot as shown in FIG. 2 (a), it was observed that the PTFE reactivity region was suppressed for anode B obtained by ‘Process-2’, which also showed improved initial coulombic efficiency (ICE) of about 86% when compared to the anode A (as depicted in Table 2).

TABLE 2

| Anode | [symbol] itial coulombic efficiency (ICE) (%) |
|---|---|
| A | 78.6 |
| B | 86 |

[symbol]

indicates data missing or illegible when filed

The improvements for anode B was observed to be due to the better particle to particle interconnection by homogeneous mixing of PTFE and fibrous second conductive carbons (without agglomeration). These improved interconnections increased the electrical conductivity of the electrodes and consequently restricts Li⁺ ions to react with fluorine from PTFE. Subsequently, anodes or cathode obtained by the ‘Process-2’ exhibited better cycle retention.

The FIG. 2b illustrates the reactivity comparison between Process-1 and Process-2. The curve which represents Process-1 showed a greater reactivity between PTFE and Li ions and a corresponding capacity fading was observed in FIG. 2c. The curve for Process-2 given in FIG. 2b showed a reduced reactivity between PTFE and Li and a corresponding improvement in SOH was seen in FIG. 2c.

FIG. 2c illustrates the State of Health (SOH) of anode electrode. SOH for Process-1 was found to be 75% at 50 cycles and for Process-2, 87% at 50 cycles. The higher SOH indicated the improved life span of the electrode.

In conclusion, homogeneous mixing of active materials with fibrous second conductive carbons and binders was achieved through ‘Process 2’, wherein, mixing of the second conductive carbon VGCF (through jet milling) after high shear mixing restricted agglomerations of the same in the prepared electrodes. The well distributed fibrous second conductive carbon (VGCF) particles in the anode electrode increased the particle-to-particle electrical conductivity. This increased the rate of electron transfer between the anode active materials and thus reduced the reduction time of PTFE by the Li⁺ ions coming from the cathodic side. This reduced reduction time led the anode electrodes to exhibit less PTFE reactivity. The electrodes prepared using ‘Process-2’ exhibited improved physical/electrical properties and electrochemical performance with cycle retention.

### Advantages of the Present Disclosure

The present disclosure provides an easy and convenient process to obtain an electrode with reduced binder reactivity, higher fibrillation, uniform conductive carbon coating and negligible agglomeration of components which led to increased capacitance, enhanced initial coulombic efficiency (ICE) and better conductivity.

The process of preparing an electrode as disclosed in the present disclosure can be used for the preparation of anodes and cathodes. The usage of different types of conducting carbons without agglomeration paves way for the upscaling of the process for the commercial purposes. The usage of fibrous carbons as second conductive carbons and pre-treated fibrillating binders as second binder points towards the advantage of compatibility and convenience of the process. By the optimisation of the process conditions and parameters with the addition of components at the proper timings resulted in an electrode with the desired properties. Further, the electrode obtained in the form of powder, has better compactness and mechanical properties owing to the free-flowing nature of the electrode powder which results in added advantage in manufacturing. In addition to the mechanical integrity of the electrode, the PTFE reactivity with the anode environment is considerably reduced. Due to the employment of second conductive carbon and effective carbon coating, the enhanced fibrillation of jet-milled second binder and increased electrical conductivity of the electrode adds up to the commercial value of the process as disclosed herein.

1. A process for preparing an electrode, the process comprising:
(a) mixing an active material, a first conductive carbon, and a first binder to obtain a first mixture;
(b) high shear mixing the first mixture with a second binder to obtain a second mixture, wherein the second binder is different from the first binder;
(c) cooling the second mixture and blending with a second conductive carbon to obtain a third mixture; and
(d) jet milling the third mixture, and processing to obtain the electrode.

2. The process as claimed in claim 1, wherein high shear mixing in step (b) is carried out at a tip speed in a range of 30 to 41 m/s, for a period in a range of 5 minutes to 60 minutes, until temperature of the mixture is in a range of 65 to 85° C.

3. The process as claimed in claim 1, wherein cooling is carried out with low-speed mixing at a tip speed in a range of 3 to 20 m/s, until temperature of the second mixture is below 19° C.

4. The process as claimed in claim 1, wherein cooling is carried out at a controlled rate in a range of 2 to 10° C. per minute for a time interval in a range of 5 to 30 minutes.

5. The process as claimed in claim 1, wherein blending the second conductive carbon is carried out at a temperature in a range of 0 to 25° C. at a tip speed in a range of 3 to 12 m/s for a period in a range of 5 minutes to 2 hours.

6. The process as claimed in claim 1, wherein the processing comprises calendaring, laminating, or combinations thereof.

7. The process as claimed in claim 1, wherein jet milling is carried out at a feeding pressure in a range of 1 to 3 Kg/cm2; a milling pressure in a range of 1 to 3 Kg/cm2; and at a temperature in a range of 10 to 25° C.

8. The process as claimed in claim 1, wherein the active material is selected from graphite, silicon, silicon-graphite, nickel-manganese-cobalt oxide (NMC), lithium-nickel-cobalt-aluminium oxides (NCA), lithium iron phosphate (LFP), or lithium-manganese-rich (LMR); and the active material is in a range of 95 to 98% (w/w).

9. (canceled)

10. The process as claimed in claim 1, wherein the first conductive carbon is selected from carbon black, graphene, mesoporous carbon, acetylene black, activated carbon, super P or mixtures thereof; and the first conductive carbon is in a weight range of 0.1 to 2% (w/w).

11. (canceled)

12. The process as claimed in claim 1, wherein the first binder is selected from polyvinylidene fluoride (PVDF), hydroxypropyl methyl cellulose (HPMC), hydroxypropyl cellulose (HPC), hydroxyethyl cellulose (HEC), sodium carboxymethyl cellulose (Na-CMC), carboxymethyl cellulose (CMC), styrene butadiene rubber, polyethylene glycol (PEG), polyacrylic acid (PAA), polyethylene oxide (PEO) or combinations thereof; and the first binder is in a range of 0.1 to 2% (w/w).

13. (canceled)

14. The process as claimed in claim 1, wherein the second conductive carbon is selected from carbon nanofiber, vapour grown carbon nanofiber, carbon nanotube, or combinations thereof; and the second conductive carbon is in a range of 0.1 to 2% (w/w).

15. (canceled)

16. The process as claimed in claim 1, wherein the second binder is jet milled prior to high shear mixing and a D50 particle size of the jet milled second binder is in a range of 50 to 300 micrometer.

17. The process as claimed in claim 1, wherein the second binder is a fibrillating binder selected from polytetrafluoroethylene, fluoroethylene vinyl ether (FEVE), or combinations thereof; and the second binder is in a range of 0.1 to 2% (w/w).

18. (canceled)

19. An electrode obtained by the process as claimed in claim 1.

20. The electrode as claimed in claim 19, wherein the electrode comprises:
a. an active material;
b. at least two conductive carbons; and
c. at least two binders.

21. The electrode as claimed in claim 19, wherein the electrode exhibits a conductivity in a range of 5 to 8 mS/cm.

22. A first electrochemical cell comprising:
a. an anode comprising the electrode obtained by the process as claimed in claim 1;
b. a cathode; and
c. an electrolyte.

23. A second electrochemical comprising:
a. an anode;
b. a cathode comprising the electrode obtained by the process as claimed in claim 1; and
c. an electrolyte.

24. A modified electrochemical cell comprising:
a. an anode comprising the electrode obtained by the process as claimed in claim 1;
b. a cathode comprising the electrode obtained by the process as claimed in claim 1; and
c. an electrolyte.

25. The electrochemical cell as claimed in claim 22, wherein the electrolyte is LiPF6 in a solvent selected from ethyl carbonate (EC), dimethyl carbonate (DMC), ethyl methyl carbonate (EMC), or combinations thereof.

26. The electrochemical cell as claimed in claim 22, wherein the electrochemical cell further comprises a separator.

27-28. (canceled)
